(19) United States
(12) Patent Application Publication
(10) Pub. No.: US 2007/0276596 A1
(43) Pub. Date: Nov. 29, 2007

(54) Route Guidance System

(75) Inventors: Jeffrey Solomon, Flitwick (GB); David Kenneth Martell, Shillington (GB)

Correspondence Address: FOLEY AND LARDNER LLP;SUITE 500, 3000 K STREET NW, WASHINGTON, DC, 20007, US

(73) Assignee: TrafficMaster PLC

(21) Appl. No.: 10/576,875

(22) PCT Filed: Oct. 25, 2004
(86) PCT No.: PCT/GB04/04514

§ 371 Date: Apr. 6, 2007

(30) Foreign Application Priority Data
Oct. 24, 2003 (GB) 0324800.2

(51) Int. Cl. G01C 21/36

(52) U.S. Cl. 701/211; 701/209; 701/202; 340/995.19

(57) ABSTRACT

A route guidance system comprising an in-vehicle device (10) and a central route advisory system (30) in which the in-vehicle device comprises an audio emitter (18) and a visual display unit (24, 26) adapted to provide audio and visual instructions to a user to perform manoeuvres required to complete an optimal route, wherein the optimal route is transmitted by the central route advisory system (30) to the in-vehicle device (10) in response to a route request from the user to a human operator in the central route advisory system (30) to a specified destination.

### BACKGROUND OF THE INVENTION

In-vehicle route guidance systems are known. However, such systems typically include their own on-board map databases. Since large amounts of data are generally required to describe maps, traditional in-vehicle route guidance systems generally include storage devices with substantial storage capacities to hold the relevant map data.

European Patent Application EP 1262936 describes a route guidance system comprising an in-vehicle device and a central route advisory system. EP 1262936 describes how the driver of a vehicle contacts the central route advisory system and indicates a required destination. The central route advisory system is also informed of the current position of the vehicle by the in-vehicle device. The central route advisory system determines the optimal route to the required destination and transmits details of the route to the in-vehicle device in a single compressed data message.

EP 1262936 further describes how during the journey, the in-vehicle device issues audible instructions to the driver as the vehicle passes route key-points along the optimal route. The instructions advise the user of future manoeuvres which the user will be required to undertake at junctions, roundabouts etc.

### SUMMARY OF THE INVENTION

According to the invention there is provided a route guidance system comprising an in-vehicle device and a central route advisory system in which the in-vehicle device comprises an audio emitter and a visual display unit adapted to provide audio and visual instructions to a user to perform manoeuvres required to complete an optimal route, wherein the optimal route is transmitted by the central route advisory system to the in-vehicle device in response to a route request from the user to a human operator in the central route advisory system to a specified destination.

Preferably, the visual display unit is a monochrome display.

Preferably, the system comprises a means for displaying on the visual display unit a junction or roundabout as the vehicle approaches it.

Desirably, the system comprises a means for displaying on the visual display unit junctions as pictographs.

Desirably, the system comprises a means of displaying on the visual display unit roundabouts as pictographs.

Preferably, the system comprises a means for indicating on the displayed pictograph the required manoeuvre.

Preferably, the system comprises a means for supplementing the visual instructions to perform a manoeuvre with audible instructions to perform a manoeuvre.

Desirably, the visual display unit provides a means of initiating an automatic route request in respect of a stored destination.

Desirably, the system comprises a means for displaying on the visual display unit the proximity of speed-cameras.

Alternatively, the visual display unit is a color display unit.

Preferably, the system comprises a means for displaying on the color display unit coloured road-maps of a particular region.

Preferably, the system comprises a means for superimposing onto the coloured road-maps the current position of the car.

Preferably, the system comprises a means for superimposing onto the coloured road-maps the pictograph of a junction or roundabout.

Desirably, the system comprises a means for providing a user-interface on the color display unit and a means for enabling the user to a make telephone call.

Desirably, the system comprises a means for providing a user-interface on the color display unit and a means for enabling the user to receive a telephone call.

Preferably, the system comprises a means for providing a user-interface on the color display unit and a means for enabling the user to receive a text-message.

According to a second aspect of the invention there is provided a route guidance system comprising an in-vehicle device and a central route advisory system in which the in-vehicle device comprises units adapted to provide instructions to a user to perform manoeuvres required to complete an optimal route, wherein the optimal route is determined by the central route advisory system using real-time historical traffic data acquired from monitored routes together with archive data acquired from non-monitored routes and transmitted by the central route advisory system to the in-vehicle device in response to a route request from the user to a human operator in the central route advisory system to a specified destination.

According to a third aspect of the invention there is provided a route guidance system comprising an in-vehicle device and a central route advisory system in which the in-vehicle device comprises units adapted to provide instructions to a user to perform manoeuvres required to complete an optimal route, wherein the optimal route is calculated by the central route advisory system using a traffic forecasting model and transmitted by the central route advisory system to the in-vehicle device in response to a route request from the user to a human operator in the central route advisory system to a specified destination.

Preferably, the traffic forecasting model is time dependent.

Preferably, the central route advisory system comprises a means for predicting future traffic conditions based on the time at which the route request was received together with the time dependent traffic forecasting model.

According to a fourth aspect of the invention there is provided a route guidance system comprising an in-vehicle device and a central route advisory system in which the in-vehicle device comprises units adapted to provide instructions to a user to perform manoeuvres required to complete an optimal route, wherein the optimal route is calculated by the central route advisory system taking into account the previous travelling direction of the vehicle, in response to a route request from the user to a human operator in the central route advisory system to a specified destination, and the optimal route is transmitted by the central route advisory system to the in-vehicle device.

According to a fifth aspect of the invention there is provided a route guidance system comprising an in-vehicle device and a central route advisory system in which the in-vehicle device comprises units adapted to provide instructions to a user to perform manoeuvres required to complete an optimal route, wherein the optimal route is calculated by the central route advisory system taking into account the previous travelling direction of the vehicle, in response to a route request from the user to a human operator in the central route advisory system to a specified destination, and the optimal route is transmitted by the central route advisory system to the in-vehicle device.

According to a sixth aspect of the invention there is provided a route guidance method comprising the steps of:
(a) receiving a call from a user's in-vehicle device indicating the user's desired destination;
(b) entering the user's desired destination into a route-guidance system;
(c) determining the current location of the user's vehicle;
(d) determining the potential routes to the desired destination;
(e) ascertaining traffic conditions along the potential routes;
(f) determining the optimal route to the desired destination using the distances of the potential routes and the traffic conditions along the routes;
(g) establishing route key-points along the optimal route;
(h) associating flags with the route key-points;
(i) transmitting the route key-points and flags to the user's in-vehicle device; and
(j) providing visual and audio instructions to the user as the user's vehicle approaches the route key-points along the optimal route.

According to a seventh aspect of the invention there is provided a route guidance method comprising the steps of:
(a) receiving a call from a user's in-vehicle device indicating the user's desired destination;
(b) determining the current location of the user's vehicle;
(c) entering the user's desired destination into a route-guidance system;
(d) determining the potential routes to the desired destination;
(e) ascertaining traffic conditions along the potential routes;
(f) determining the optimal route to the desired destination using the distances of the potential routes and the traffic conditions along the routes;
(g) establishing route key-points along the optimal route;
(h) associating flags with the route key-points;
(i) transmitting the route key-points and flags to the user's in-vehicle device; and
(j) providing instructions to the user as the user's vehicle approaches the route key-points along the optimal route.

According to an eighth aspect of the invention there is provided a route guidance method comprising the steps of:
(a) receiving a call from a user's in-vehicle device indicating the user's desired destination;
(b) entering the user's desired destination into a route-guidance system;
(c) determining the current location of the user's vehicle from a dual multi-frequency tone transmission from the user's in-vehicle device;
(d) determining the potential routes to the desired destination;
(e) ascertaining traffic conditions along the potential routes;
(f) determining the optimal route to the desired destination using the distances of the potential routes and the traffic conditions along the routes;
(g) establishing route key-points along the optimal route;
(h) associating flags with the route key-points;
(i) transmitting the route key-points and flags to the user's in-vehicle device; and
(j) providing instructions to the user as the user's vehicle approaches the route key-points along the optimal route

Alternatively, the current position of the user's vehicle is determined from an ISDN sub-addressing transmission from the user's in-vehicle device.

According to a ninth aspect of the invention there is provided a route guidance method comprising the steps of:
(a) receiving a call from a user's in-vehicle device indicating the user's desired destination;
(b) entering the user's desired destination into a route-guidance system;
(c) determining the current location of the user's vehicle;
(d) determining the potential routes to the desired destination;
(e) ascertaining traffic conditions along the potential routes;
(f) determining the optimal route to the desired destination using the distances of the potential routes and the traffic conditions along the routes;
(g) establishing route key-points along the optimal route;
(h) associating flags with the route key-points;
(i) transmitting the route key-points and flags to the user's in-vehicle device;
(j) using route convergence model to determine the direction in which the user's vehicle is travelling once the vehicle commences the journey along the optimal route;
(k) providing visual and audio instructions to the user as the user's vehicle approaches the route key-points along the optimal route.

Preferably, the in-vehicle device uses the route convergence model to display the current route on which the vehicle is travelling.

### ADVANTAGES OF THE INVENTION

Audible instructions of the type described in EP 1262936 can sometimes be ambiguous or misleading. To overcome this problem, the present invention includes display devices to provide visual aids to supplement the audio instructions provided by the in-vehicle device. These display devices also provide the user with additional information such as a distance count-down to a junction, estimated time of arrival at a destination, proximity of speed cameras etc.

A first embodiment of the invention includes a monochrome display unit which displays junctions, roundabouts etc. in simple pictographic format. The second embodiment of the invention includes a color display unit which displays road-maps and depicts the present location of the vehicle on the map. The color display unit also provides a user interface which enables the user to make and receive voice calls (other than to the call central route advisory system) and to receive text messages.

The display units also provide user interfaces to the route guidance system and enable a user to make automatic route requests based on the post-code of a destination, or previously stored favourite destinations or previously visited destinations.

The first and second embodiments of the present invention also includes a mechanism of encoding pictograms representing junctions roundabouts etc. in a data efficient manner so that the resulting data can be readily transmitted to the user's in-vehicle device.

The fifth embodiment of the present invention employs a novel SMS messaging sequence to the call centre advisory system.

EP 1262936 used SMS messaging to transmit the vehicle's current GPS position to the central route advisory system. Since SMS messaging may be expensive, the sixth and seventh embodiments of the present invention employ a less expensive dual-tone-multi-frequency (DTMF) system and/or ISDN sub-addressing mechanism for transmitting the vehicle's current location to the central route advisory system.

EP 1262936 described a route guidance system which combined map information and historical and real-time traffic information to determine the optimal route to a required destination. However, the route guidance system described in EP 1262936 relied entirely on information acquired at the time at which the route request was made. The system described in EP 1262936 did not take into account the fact that traffic conditions are dynamically variable, so that the traffic conditions prevailing at a particular point in time might not be applicable an hour later. The fourth embodiment of the present invention employs a time dependent forecasting model to predict future traffic conditions and in particular to predict the traffic conditions that a driver might expect to encounter on entering a particular route segment. The forecast estimate is determined from the time at which the route request is received by the central route advisory system. The use of the time dependent traffic forecasting model enables the route guidance system to more accurately reflect the dynamic nature of traffic flow.

Nine embodiments of the invention will now be described with reference to the accompanying drawings in which

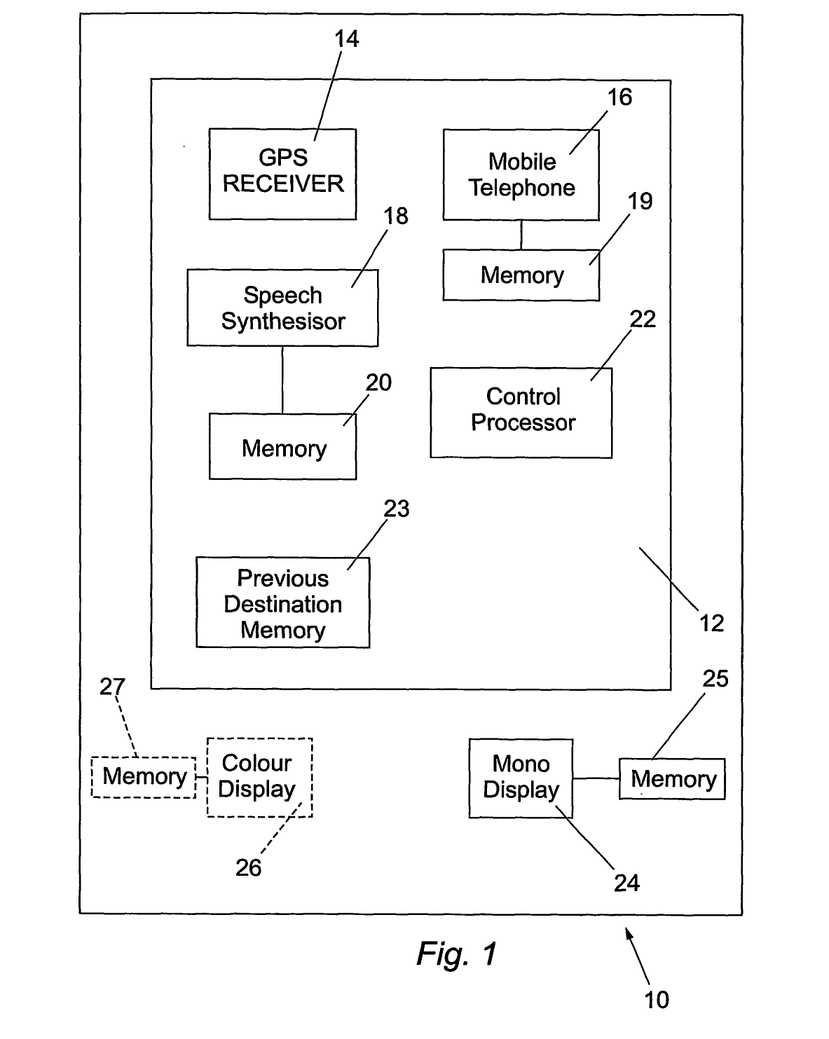

FIG. 1 is a block diagram of the in-vehicle device showing the color and monochrome display units of the first and second embodiments of the route guidance system;

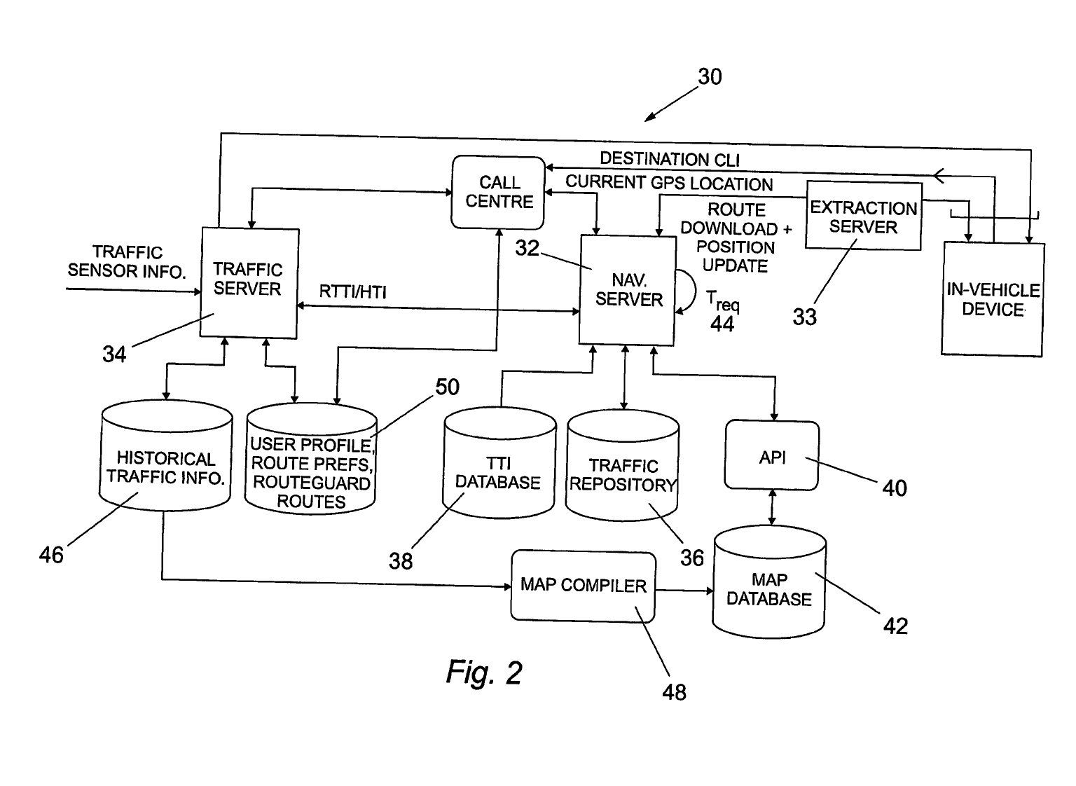

FIG. 2 is a block diagram of the hardware components of the central call centre advisory system of the routing guidance system;

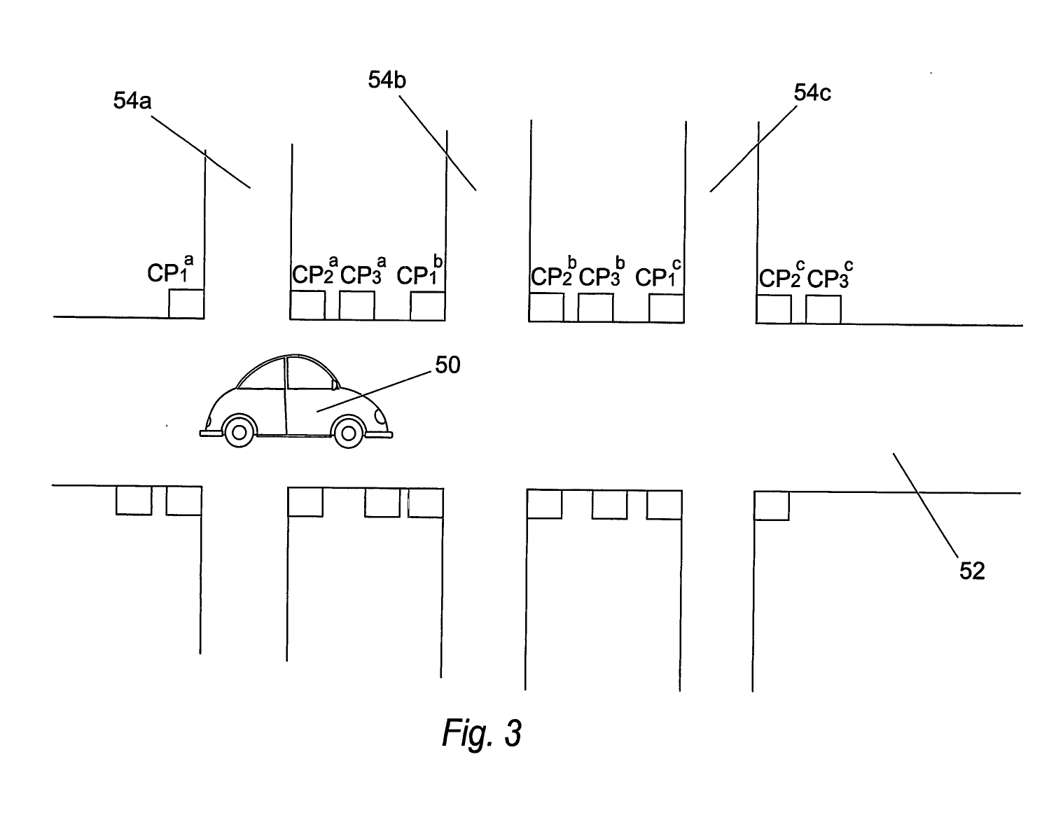

FIG. 3 is a schematic representation of an example scenario demonstrating the function of a confirmation point triplet;

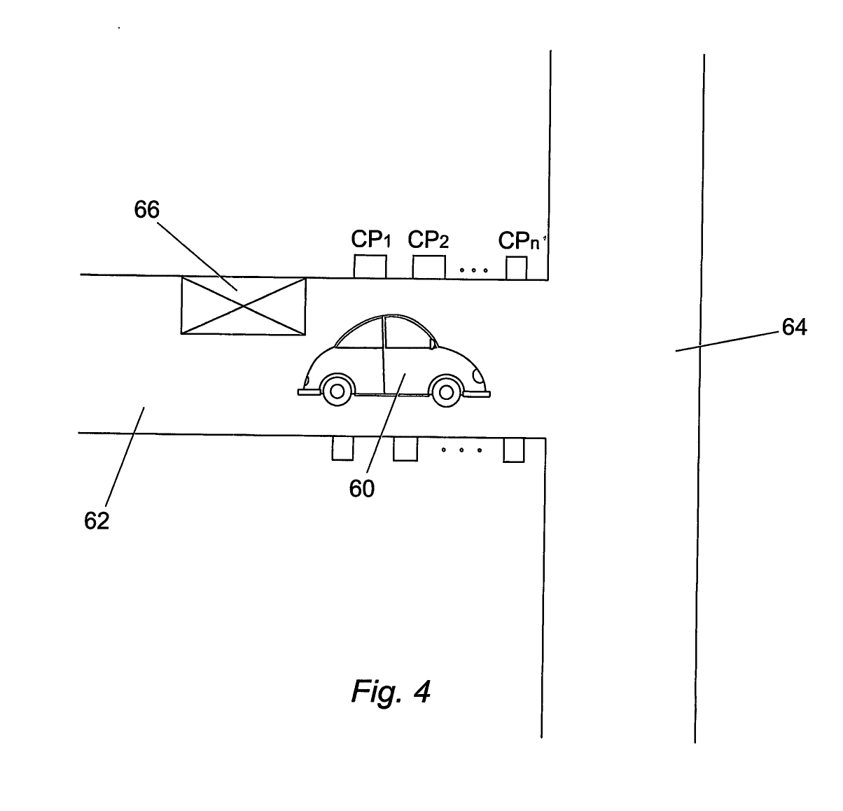

FIG. 4 is a schematic representation of an example scenario demonstrating the function of benign confirmation points;

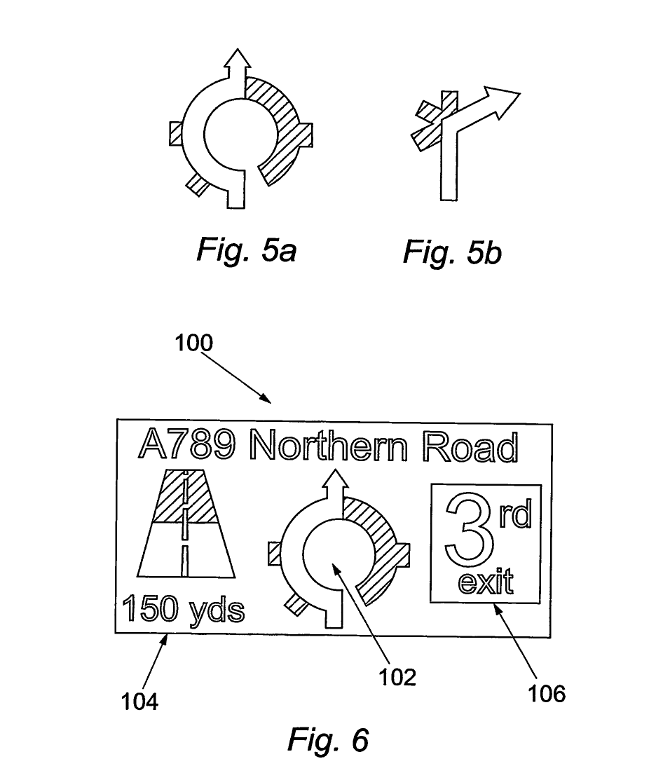

FIG. 5a is a pictogram of a roundabout as would be displayed by the monochrome and color display units;

FIG. 5b is a pictogram of a junction as would be displayed by the monochrome and color display units;

FIG. 6 is screen shot of the normal display mode of the monochrome display units;

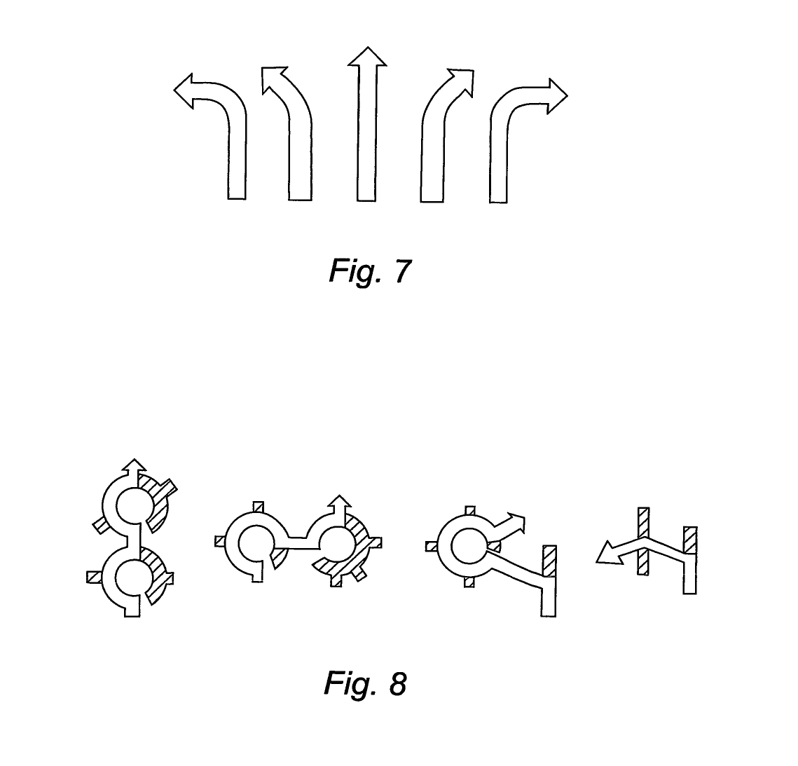

FIG. 7 is a pictogram of bent variants of the straight ahead arrow denoting bends on the route ahead, as would be displayed by the monochrome and color display units;

FIG. 8 is a series of pictograms of compound junctions that would be displayed by the monochrome and color display units; and

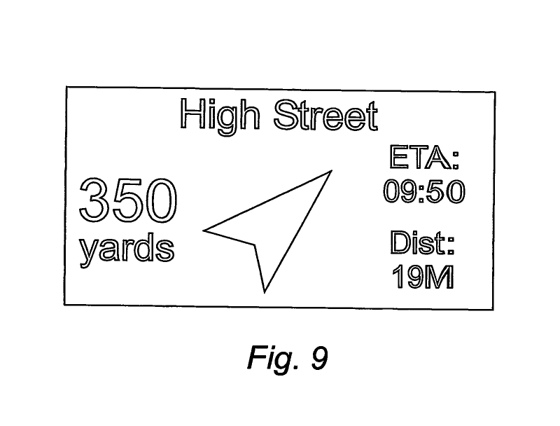

FIG. 9 is a screen shot of the compass aid screen of the monochrome display unit.

The following description will first discuss the hardware architecture of the route guidance system. The role and function of route key-points in the route guidance system will then be described followed by a discussion of the route convergence model and the smart start system. The description will finally discuss the software architecture employed in the first and second embodiments of the invention which include the monochrome and color display units respectively.

Hardware Architecture of the Route Guidance System

As described in EP 1262936, the route guidance system comprises in-vehicle devices and a central route advisory system. An in-vehicle device is installed in each user's vehicle and communicates with the central route advisory system through a mobile telephone network. An overview of the architectures of the in-vehicle devices and the central route advisory system will be discussed in turn below.

Referring to FIG. 1 and the first embodiment of the route guidance system, an in-vehicle device 10 comprises a navigation unit 12 which in turn comprises a GPS (Global Positioning System) receiver 14, a mobile telephone device 16 and a memory 19 for the mobile telephone device 16. The navigation unit 12 further comprises a speech synthesiser 18, a control microprocessor 22 and an on-board memory 20 for the speech synthesiser 18. The memory 20 for the speech synthesiser 18 stores a variety of words and phrases which acts as a vocabulary for the in-vehicle device. The navigation unit 12 finally comprises a memory for storing previous destinations visited by the user 23. The speech synthesisor is coupled to any suitable form of audio emitter, for example, an amplifier and speaker or an existing in-vehicle audio system.

The in-vehicle device 10 further comprises a monochrome video display unit 24 and its own on-board memory 25. The memory 25 for the monochrome display unit 24 stores the latitude and longitude details of user-defined destinations.

The monochrome display unit 24 is a 128×64 pixel FSTN LCD, although it will be appreciated that other monochrome display devices could also be used. The monochrome display unit includes a touch-screen comprising eight fixed touch areas. The monochrome display is back-lit with a blue LED edge light which can be dimmed at night for safe viewing at night. The contrast of the monochrome display is automatically adjusted in response to changes in ambient temperature. The monochrome display is connected to the in-vehicle device by a bi-directional RS232 interface and in use is further connected to an ignition switched vehicle power supply.

In the second embodiment of the route guidance system, the monochrome display unit 24 and its memory 25 is replaced with a color display unit 26 and its memory 27. The color display unit is 5.7 inch diagonal color QVGA (320×240 pixel) STN LCD incorporating a touch screen, although it will be appreciated that other color displaying devices could also be used. The monochrome display unit memory 25 and color display unit memory 27 both also store graphic elements used to construct pictograms in accordance with encoded instructions from the central route advisory system.

The monochrome display unit memory 25 and color display unit memory 27 both also store graphic elements used to construct pictograms in accordance with encoded instructions from the central route advisory system.

Referring to FIG. 2, the central route advisory system 30 comprises a navigation server 32, an extraction server 33 and a traffic server 34. The navigation server 32 calculates an optimal route to a destination on receipt of a user request. The optimal route is determined using data from the traffic server 34. The navigation server 32 then transmits details of the optimal route to the extraction server 33 which formats the data for transmission to the user's in-vehicle device as a compressed data message.

Looking at the relationship between the navigation server 32 and the extraction server 33 in more detail, the navigation server 32 typically expresses a calculated optimal route in NavML (or other suitable route engine output). The extraction server 33 then extracts the relevant information from the NavML (or other suitable route engine output) stream to construct a route_summary message and encodes it for wireless transmission to the user's in-vehicle device.

Route_summary messages typically include a set of GPS positions of route key-points along the optimal route. In general a number of the route key-points are included in any optimal route spaced at intervals of approximately 1 mile. In particular, route key-points are included at positions along the route where an instruction must be given to the driver, or at positions where it might be possible for a driver to make a wrong-turning or take the wrong exit from a roundabout etc. and thereby deviate from the optimal route.

As part of the audio-prompting mechanism of the route guidance system, Route_summary messages typically also include a number of flags or tokens which are associated with individual route key-points. The flags are used for selecting individual words or phrases from the in-vehicle device's on-board memory and playing the words or phrases to the driver. The flags trigger the selection and playing of a word or phrase as the vehicle passes an associated route key-point. Consequently complete sentences can be constructed as the vehicle passes successive route key-points.

A description of the role and function of route key-points will follow the description of the hardware architecture of the route guidance system.

In the first and second embodiments of the route guidance system, a route-message typically uses information extracted from the NavML (or other suitable route engine output) stream to encode pictograms representing junctions and roundabouts on the calculated optimal route.

For example, if the optimal route includes a roundabout, details of the roundabout including its structure, required entrance and exit are transmitted in NavML form (or other suitable route engine output) by the navigation server 32. The extraction server 33 extracts the relevant information from the NavML (or other suitable route engine output) stream and encodes it for transmission to the in-vehicle device. The encoding process involves representing the roundabout with a specific binary code recognised by the in-vehicle device.

As indicated above, the monochrome and color display unit memory chips 25 and 27 store specific graphic elements for constructing pictograms. In the case of the roundabout example, on receipt of the roundabout identifier from the extraction server 33, the display unit memory chips 25 and 27 retrieve the circular graphic component used for representing roundabouts.

The roundabout graphic element has twelve slots about its circumference. On receipt of a code identifying the required entrance to the roundabout, a linear graphic element is inserted in the circular graphic element at slot zero. Using a clock as an analogy for the circular graphic element, slot zero is located at the six o'clock position. This leaves eleven remaining slots for depicting the potential exits from the roundabout. Linear graphic elements are retrieved from the monochrome and color display unit memory chips 25 and 27 and positioned in slots around the circular graphic element moving in a generally clockwise direction according to the specific binary instructions transmitted by the extraction server 33. A further code is transmitted by the extraction server 33 to specifically identify the required exit from the roundabout. A similar process is used for encoding and depicting radial junctions.

Route_messages also typically include textual entries for the names of the required entry and exit roads from any junctions on the optimal route.

In terms of the architecture of the central route advisory system 30, the navigation server 32 communicates with a traffic repository 36 which stores historical traffic information and road closures data. Historical data is data which has been compiled over a period of time to reflect changes in traffic patterns that occur depending upon the time of day or the day of the month in question (e.g. rush hour traffic varying by day of week and season).

The navigation server 32 also communicates with an application programming interface (API) 40. The API 40 facilitates communication between the navigation server 32 and a map database 42 via requests and responses. The map database 42 contains map data together with real time traffic information and historical traffic information. In effect, the navigation server 32 calculates an optimal route for a user, taking into account the distances to be travelled along different routes and traffic conditions along the routes. Traffic conditions are used to estimate the speed at which a vehicle might be expected to travel along a candidate route and thus the delay that a driver might experience along that route. The inclusion of traffic condition information into the algorithm for determining the user's optimal route is known as “traffic impacted routing”.

In a fourth embodiment of the route guidance system, the route optimisation calculations performed by the navigation server are further enhanced by the use of a time dependent traffic forecasting model. The traffic forecasting model forecasts the traffic conditions that might be expected along a route segment depending upon the time at which a route request was received (T_{req} 44). The forecasting model is designed to be time dependent, so that it can more accurately reflect the dynamic and time-varying nature of traffic congestion.

Using the time dependent traffic forecasting model, the navigation server adjusts the speeds at which the user might be expected to travel along candidate route segments according to the traffic conditions that might be expected to exist along these route segments. As mentioned above the traffic conditions are forecasted based on the time at which a route request is received (T_{req} 44).

As a simple example, consider a journey at 5 p.m. for which there are two potential routes to the required destination (i.e. Route_{A} and Route_{B}). Suppose Route_{B} is longer than Route_{A}. However, let us also suppose that during rush-hour (i.e. 5 p.m.) Route_{A} is considerably busier than Route_{B}. In this circumstance a driver might be expected to travel more slowly on Route_{A} than they might on Route_{B}. Consequently, whilst Route_{B} might be longer than Route_{A} the driver might nonetheless have a journey of shorter duration taking Route_{B} rather than Route_{A}.

Looking at the time dependent traffic forecasting model in more detail, the model generates a forecast from data contained in an averaged historical traffic archive together with a forward calendar. The records contained in the averaged historical traffic archive represent average traffic conditions measured over an extended period (e.g. showing differences between week-day and weekend traffic conditions along a particular route segment). The forward calendar is used by the forecast model to select a record from the historical traffic archive that is most relevant to the date at which the route request is made. The forward calendar can also be used as part of a long-term forecasting system if a route request is made in respect of a future date. A short-term forecast of the expected traffic conditions along a candidate route segment is made by the forecasting model using the selected historical traffic record together with the time at which the route request is made (T_{req} 44) and the real-time current traffic conditions recorded at the time the route request was made.

In a third embodiment of the invention, the navigation server 32 also communicates with a typical traffic information (TTI) database 38. TTI refers to traffic information relating to un-monitored routes e.g. non-trunk A roads, minor roads and urban streets. The TTI database 38 contains a static data-set that can be used by the navigation server 32 to calculate optimal routes for any time of any day.

The data contained in the TTI database 38 are equivalent to the data provided for the monitored roads by the long-term forecast. As there is no real-time data for these roads this data is not updated in real-time to produce a more accurate short-term forecast for these route segments. However, the TTI data can be over-ridden on the occurrence of specific traffic events.

Without the use of the time-dependent traffic forecasting model, the navigation server 32 can only base its route calculations on the conditions of the route at the time of calculating the route. Clearly, such route calculations do not consider the changes in the traffic conditions on a given route segment that might have occurred between the time of the original route calculations and the time at which the driver reaches the route segment in question.

In addition to providing route information, the central route advisory system 30 can provide a user with traffic congestion information. Traffic congestion information is acquired by the traffic server from a variety of sources such as roadside speed cameras and traffic reports.

The traffic server 34 communicates real time traffic information and historical traffic information to the navigation server 32 and additionally transmits historical traffic information to a historical traffic information database 46.

The historical traffic information database 46 provides a map compiler 48 with historical traffic information. The map compiler 48 formats map data together with real time traffic information and historical traffic information and the standard speed for a given road link. The map compiler 48 transmits this information to the map database 42 which in effect contains standard default expected speeds (impedances) along road-links.

The traffic server 32 also communicates with a users database 50. The users database 50 stores user profile data (e.g. user's name & address etc.). This data can be amended in accordance with user's requirements (e.g. by the user through an internet connection or by customer services representatives).

Taking a more detailed look at the relationship between the in-vehicle device 10 and the central route advisory system 30, in use, a user may use the in-vehicle device 10 to manually contact a call centre operator at the central route advisory system 30 and provide his required destination. The operator then supplies the required destination to the navigation server 32.

The system employs two different approaches to transmitting the vehicle's current position. In the first approach whilst the user is speaking to the call-centre operator, the in-vehicle device's navigation unit transmits its calling line identity (CLI) and the current GPS position of the vehicle in an SMS message to the navigation server 32. The advantage of transmitting the navigation unit's CLI before the voice-call is established is that the SMS message containing the CLI has more time to reach the navigation server 32. However, the disadvantage of this approach is that there is a delay in the establishment of the voice-call. In a fifth embodiment of the route guidance system, a second approach is employed in which the navigation unit transmits the SMS message to the navigation server 32 before the voice-call is set up between the driver and the call-centre operator. The advantage of this approach is that there is less delay in establishing a voice-call to a call-centre operator. However, more of the duration of the voice-call is taken up with transmitting the CLI to the navigation server than with the first approach.

On receipt of the route request, the navigation server 32 calculates the optimal route to the required destination, taking into account the user's preferences and traffic conditions, particularly traffic congestion. As discussed above, the navigation server 32 may also use a time-dependent traffic forecasting model to determine the optimal route for the user.

The navigation server 32 then transmits a response to the optimal route query in a NavML (or other suitable route engine output) stream to the extraction server 33. The extraction server 33 extracts the relevant information from the NavML (or other suitable route engine output) stream and encodes into a compressed data message suitable for wireless transmission to the in-vehicle navigation unit. The compressed data message includes all the route key-points on the optimal route together with flags at associated route key-points for triggering audible manoeuvre prompts to the user. In the case of the first and second embodiments of the route guidance system, the compressed data message also includes encoded pictograms and textual information.

The communications channel between the in-vehicle device and the central route advisory system 30 is then closed and the extraction server 33 does not communicate any further with the in-vehicle device unless the driver requests a different route to the same or a different destination or traffic conditions have changed since the original route request.

As described above, as the vehicle progresses along the optimal route and passes individual route key-points a flag may be activated triggering the selection of a word or phrase from the in-vehicle device's on-board memory. The word or phrase is then played to the driver through the speech synthesiser to provide audible prompts of required manoeuvres, oncoming junctions etc.

In the first and second embodiments of the route guidance system, as the vehicle progresses along the optimal route and passes individual route key-points, pictograms displaying nearby junctions or roundabouts are displayed on the in-vehicle device's monochrome or color display units, together with visual indications of the required manoeuvre and the names/numbers of the entry and exit routes from the junction or roundabout in question. Further discussions of the manner in which junctions and roundabouts are displayed will follow in the discussion of the software architectures of the monochrome and color display units.

Returning to the manner in which the in-vehicle device transmits a route request to the central route advisory system 30, since SMS messaging may be costly, the in-vehicle navigation unit may use two less costly, alternative means of transmitting the current GPS position of the vehicle. In the sixth embodiment of the route guidance system, the navigation unit transmits the GPS position of the vehicle to the navigation server 32 using dual-tone-multi-frequency (DTMF) tones at the start of the user's voice-call to the central route advisory system 30.

In the seventh embodiment of the route guidance system, the in-vehicle navigation unit transmits the vehicle's current GPS position to the navigation server 32 using ISDN sub-addressing as the voice-call to the central route advisory system 30 is being set up. ISDN sub-addressing may be used for this purpose because the ISDN specification allows for additional characters to be appended to a called telephone number. These characters are usually used for further call routing once a call is connected. However, the number of extra characters that may be appended to a called telephone number is also sufficient to enable the transmission of an encoded geographic location.

All of the above methods of transmitting a route request to the central route advisory system 30 have relied upon a manual process of establishing a voice-call to the call-centre advisory system and telling the call-centre operator the required destination, whereupon the operator manually enters the required destination into the navigation server 32.

In addition to the above manual voice-call based route request process, the route guidance system can also support a process for automatically making a route request. In particular, the user can use the in-vehicle navigation unit to automatically send a route request to a specified or desired destination to the central call centre advisory system navigation server by using the favourites function or previous destination function.

Role and Function of Route Key-Points

Route key-points can be classified as preparation points, warning points, instructions points, manoeuvre points and confirmation points. A preparation point is positioned along a selected route before a location where a manoeuvre must be performed by the user to reach the required destination. The purpose of the preparation point is to provide a warning to a driver to prepare to perform the required manoeuvre. A typical audio prompt for a preparation point would be “prepare to turn left in 6 yards”.

A warning point is positioned closer to the location of the required manoeuvre than a preparation point. A warning point similarly serves to warn the driver that he will be required to perform a manoeuvre soon. However, it should be noted that in the case where a driver might be required to perform a series of manoeuvres within a short distance of each other it might not be possible to place a preparation point and warning point before each manoeuvre.

An instruction point is placed very close to the location where the required manoeuvre must be performed. A typical audio prompt for an instruction point would be “Please turn left”.

A manoeuvre point is a point along the prescribed route where a manoeuvre must be performed by the driver. These points are used internally by the route guidance system and no instructions are given to the driver as they pass these points.

There are two forms of confirmation points, spoken and non-spoken. A spoken confirmation point provides audible confirmation to the driver that they have completed a required manoeuvre correctly. A typical spoken confirmation point prompt might be “continue driving for 5 yards”.

A non-spoken confirmation point does not provide an audible prompt to the driver, but instead is used by the route guidance system to ensure that the vehicle is being driven along and has not deviated from the prescribed optimal route.

Looking firstly at spoken confirmation points, take for example, the situation shown in FIG. 3. In this example a car 50 is travelling along a main road 52 from which there are a number of side-roads 54a, 54b and 54c. The prescribed optimal route requires the driver of the car 50 to continue along the main road 52. Thus if the driver drives the car 50 onto one of the side roads 54a, 54b or 54c, the car will no longer be following the prescribed optimal route and can be said to be “off-route”.

In order to determine whether or not a car has been driven “off-route” (onto one of the side roads), a set of three confirmation points (known as a CP triplet) is positioned around each of the junctions with the side-roads. The CP triplet is designed so that a first confirmation point CP₁ is situated before each junction and the two remaining confirmation points CP₂ and CP₃ are positioned after each junction with CP₂ being positioned closer to the junction than CP₃.

CP₁ is known as a pre-junction confirmation point and CP₂ and CP₃ are collectively known as post-junction confirmation points. Two post-confirmation points are used in the CP triplet to introduce redundancy into the “off-route” detection system to cope with mapping and GPS errors in the system. For the example shown in FIG. 3, the CP triplet associated with each side road 54a, 54b and 54c are designated with a, b and c superscripts respectively.

Returning to the example shown in FIG. 3, as mentioned previously the car 50 is being driven along main road 52 and is approaching the side road 54b. If the car 50 passes CP₁^{b} and CP₂^{b} or CP₃^{b}, it is clear that the vehicle is correctly following the optimal route and has not been driven down the side road 54b. However, if the car 50 passes CP₁^{b}, but does not pass CP₂^{b} or CP₃^{b}, it is clear that the car 50 has been driven onto side road 54b and is thus “off-route”. In this circumstance, the in-vehicle device issues a prompt to the driver warning him that he has driven off the prescribed optimal route.

Having so far described the role of spoken confirmation points in CP triplets, the description will now turn to the role of non-spoken confirmation points.

Consider, for example, the situation shown in FIG. 4 in which a car 60 is parked by the side of a road 62. The road ends in a T-junction 64 and the prescribed optimal route requires the driver to turn left onto the T-junction 64. Under normal circumstances a preparation point, warning point and instruction point would have been positioned before the T-junction, to warn the driver that he is approaching the junction and advising the driver of which direction to turn at the junction. However, given the limits to the resolution of domestically available GPS, it is conceivable that the car 60 might have been parked at a position 66 between the instruction point for the T-junction 64 and the manoeuvre point representing the T-junction 64 itself. In this case, the driver would not receive an instruction as to which direction to turn at the T-junction 64. To overcome this problem, multiple confirmation points CP₁ to CPₙ are spaced at close intervals along the road 62. The route message summary transmitted to the in-vehicle device from the central route advisory centre includes a flag for each of the confirmation points indicating that the driver should be advised to “turn left at the junction”. Consequently, even though the car might miss the preparation, warning and instruction points for the junction, the driver will nonetheless receive instructions as to which direction to turn on the junction.

However, since there may be several confirmation points located between the original parking position 66 of the car 60 and the T-junction 64, it would be undesirable to have the same “turn left at the junction” message repeatedly played to the driver as the car 60 passes each of these confirmation points. To overcome this problem, as the car 60 passes the first confirmation point after the parking position 66, the driver is prompted to “turn left at the junction” and the remaining confirmation points on the road 62 are converted into non-spoken confirmation points, so that the prompt is not sent to the driver again as the car 60 passes the remaining confirmation points to the T-junction 64. Such non-spoken confirmation points are also known as “benign” confirmation points. An exception to this procedure exists if the vehicle is required to drive across a main road to reach the T-junction. In this case a warning is issued to the user as he approaches the main road.

The Smart Start System and Branch Convergence Model

As discussed above, any route from a first location to a second location is characterised by the route guidance system by a number of route key-points which include locations at which specific manoeuvres must be performed by the driver (e.g. turn right at the T-junction etc.) or locations at which the progress of a vehicle can be checked to determine whether the vehicle is still on the correct route.

In general, from any particular starting point there may be many different alternative routes or “branches” to the required destination. As the journey progresses the number of alternative routes to the destination steadily decrease, until all the alternative routes eventually converge into a single “onward route” to the destination. Since each alternative route is characterised by a set of route key-points, the start of any journey is similarly characterised by the presence of a number of different sets of route key-points, one for each alternative route to the destination. As the journey progresses, the process of route convergence is reflected in a steady decrease in the number of sets of route key-points which can be used to describe the journey.

Consider for example, a car parked on a street. The car may be pointed in one of two directions on the street and thus there are two directions in which the car may progress down the street from its parking position (and thus two potential branches from the starting position). If the car passes a route key-point situated at either end of the street it is possible to determine in which direction the car is travelling and thus the branch corresponding to the direction in which the car did not travel disappears.

Software Architecture of the First and Second Embodiments of the Route Guidance System

### (A) Monochrome Display Unit Software

The main purpose of the monochrome display unit is to provide user guidance to a user to supplement the audible instructions issued by the in-vehicle device.

The monochrome display unit has a number of different display modes including a normal display, a compass display, a menu display and a guidance inactive display. These display modes will be described in more detail below.

### (1) Normal Display Mode

The information displayed by the monochrome display unit consists primarily of graphical icons representing junctions and roundabouts etc. as seen in FIGS. 5a and 5b. The purpose of such displays is to clarify ambiguous audible instructions issued by the in-vehicle device.

The normal screen displayed by the monochrome display unit is shown in FIG. 6 and comprises four main sections, namely a target/current road section 100, a junction pictogram/straight ahead arrow section 102, a distance countdown section 104 and an information zone section 106. These sections will be described in more detail below.

(i) Target/Current Road Section 100

This section shows the number and/or name of the road that the vehicle is currently on and the number and/or name of the road onto which the vehicle should turn during a manoeuvre. When driving straight ahead the current road will be shown.

(ii) Junction Pictogram/Straight Ahead Arrow Section 102

This section displays a pictogram depicting a roundabout or radial junction such as those shown in FIGS. 5a and 5b. The display is initiated when the vehicle passes a preparation point and continues to be displayed during the subsequent manoeuvre. When driving straight ahead, an arrow symbol is used instead of the roundabout/radial junction pictogram. The arrow symbol can be displayed in a variety of curved forms as shown in FIG. 7 to reflect changes in road direction.

Both the radial and roundabout pictograms comprise a central point from which 12 branches are disposed at 30° degrees angle relative to each other. The required route through the roundabout or radial junction is highlighted on the pictogram.

The monochrome display unit also displays pictograms depicting compound junctions, such as those seen in FIG. 8. These pictograms essentially comprise assemblies of the roundabout and radial junction pictograms previously discussed.

If the navigation unit of the in-vehicle device detects that the vehicle has passed an appropriate confirmation point, it is clear that the driver has correctly completed the required manoeuvre and the junction pictogram is replaced by the straight ahead pictogram.

(iii) Distance Countdown Section 104

This section provides a graphical and/or numeric representation of the remaining distance until a manoeuvre is to be executed (the “manoeuvre point”).

(iv) Information Zone 106

This section is used to display the estimated time of arrival (ETA) and distance to the required destination This section can also be used to display warnings to the driver of oncoming speed cameras and to indicate the speed limit in the vicinity of a speed camera.

### (2) Compass Display Mode

At the start of a journey, or in the event that a vehicle deviates from the prescribed optimal route. The normal display (described above) is changed to a “compass” type display as shown in FIG. 9 comprising an arrow shaped indicator (the compass arrow) of the direction of travel.

If the vehicle is starting a journey, the compass arrow points towards the first route key-point on the prescribed optimal route and the display provides an indication of the distance to this point and its associated road name.

As described in an earlier example, in the case of a car starting a journey from a position parked by the side of a road, it is not possible to determine the direction in which the car is pointed and thus, until the vehicle has moved it is not possible to determine the direction in which it is travelling. In this circumstance, the most recent travel direction of the car prior to the present journey is stored by the in-vehicle device and used to calculate the direction in which the compass arrow on the monochrome display should point. In the case where a vehicle has deviated from a prescribed optimal route, the compass arrow points towards the final destination point and an “off route” warning is displayed instead of the road-name of the next route key-point on the prescribed optimal route.

### (3) Menu Display Mode

The touch screen of the monochrome display unit acts as a user interface to the in-vehicle device. Touching the screen activates a menu of functions including:

(i) Call centre

(ii) Advanced guidance

(iii) Mute

(iv) Repeat

(v) SOS

(i) Call Centre

Activating the call centre function initiates a manual route-request to the call centre advisory system.

(ii) Advanced Guidance

The advanced guidance menu option provides access to a sub-menu containing additional guidance-related options including:
(a) Presets 1 to 9
(b) Re-route
(c) Cancel
(d) Suspend/Resume

These options will be discussed in more detail below.

(a) Presets 1 to 9

This option allows the selection of destinations that have been preset via a web site. Selecting a destination, causes the in-vehicle device to send an automated request to the call centre advisory system for a route to the destination.

(b) Re-route

The re-route option allows a user to invoke a routing call to determine a new route to the currently selected destination. If guidance to the destination is not already in progress, the re-route option is inactivated.

(c) Cancel

This option enables a user to abandon route guidance.

(d) Suspend/Resume

Selecting the suspend option causes the in-vehicle device to mute guidance and traffic related audible instructions and suppress pictograms and re-routing advice. In the meantime, the in-vehicle device continues to scan and match route key-points along the prescribed optimal route.

(iii) Mute

This option silences any audible prompt that is being issued by the in-vehicle device.

(iv) Repeat

This option repeats the last audible prompt issued by the in-vehicle device.

(v) SOS

The SOS option allows a user to make a voice call to a preset emergency and/or breakdown telephone number.

### (4) Inactive Guidance Display Mode

When the user has not requested route guidance (i.e. guidance is inactive), the monochrome display provides general information to the user. The information displayed by the monochrome display unit in such circumstances includes
(a) the current time
(b) speed camera warnings
(c) a graphical compass depicting the current direction of travel.

### (B) Color Display Unit Software

In common with the monochrome display unit, the color display unit is designed to provide visual prompts to a driver to supplement the audible instructions issued by the in-vehicle device.

The color display unit is capable of displaying much more sophisticated graphics than the monochrome display unit and in particular is not restricted to pictographic displays but is also capable of displaying coloured road maps showing the relative position of the vehicle and nearby roundabouts and junctions.

As with the monochrome display unit, the color display unit has a number of display modes. However, regardless of which display mode is activated on the color display unit, there is always an area reserved at bottom of screen for displaying:
(a) the remaining distance to the destination
(b) the estimated time of arrival at the destination
(c) an indication of whether traffic congestion has been detected within the map area displayed on the screen at any given time

The display modes of the color display function include:

(A) Map Display Mode

(B) Guidance Active Mode

(C) Guidance Inactive Mode

(D) Help Mode

The display modes will be described in more detail below.

### (A) Map Display Mode

The principal display mode of the color display unit is the map display mode. The color display unit operates in map display mode even if the in-vehicle device does not contain a navigation unit. If the in-vehicle device does not contain a navigation unit the color display unit does not display any navigation options. When operating in map display mode, the color display unit displays a road map of the relevant country which can be zoomed to different degrees of magnification in accordance with user demands. In particular, the road maps can be displayed at magnifications between 0.4 pixels per mile (in which the entire UK mainland displayed on the screen) and 100 pixels per mile (wherein the screen width covers approximately 3 miles). At higher levels of magnification, the map display shows motorway and trunk road networks and additional less significant roads.

Map Display Mode Menus

A number of functions are available to the user when the color display unit is operating in map display mode, these functions can be divided into

(1) basic functions

(2) advanced functions

(3) telephone functions

The advanced functions include the following:

(a) a live traffic information function;

(b) a current route display function;

(c) a junction display function;

(d) a compass aid function,

(e) an exit indicator function; and

(f) a safety camera warning function.

All the functions will be described in more detail below.

### 1. Basic Map Display Mode Functions

The basic map display mode functions include a vehicle location information function and an auto-locate function. Both basic map display functions will be described in turn below.

(a) Vehicle Location Information

If a navigation unit is installed in the in-vehicle device, the navigation unit can determine the GPS location of the vehicle. The current GPS co-ordinates of the vehicle are used to position a vehicle icon on the currently displayed map, at a point reflecting the current position of the vehicle in relation to the map. The navigation unit can also use acquired GPS data to determine whether or not the vehicle is moving. If the vehicle is moving the vehicle icon displayed on the current map is depicted with an indication of the direction of movement.

If the navigation unit cannot obtain a valid GPS fix and thereby determine the current location of the vehicle, the vehicle icon is displayed in accordance with the most recent previously determined GPS location of the vehicle. Vehicle icons are displayed in one of two colours to enable a driver to distinguish between vehicle icons displayed using a current GPS fix and those using a previous GPS fix.

At all levels of zoom apart for the outermost (whole of the relevant country), the map display is provided with a pan option which enables the map to be panned at the same level of zoom in one of eight directions. To facilitate the panning operation, a set of eight pan arrows is always displayed on a map.

(b) Auto-Locate Function

In order to reduce the amount of required interaction between the driver and the controls of the color display unit, the auto-locate function can be used to automatically pan a displayed map, so that the map tracks the location of the vehicle in accordance with the most recently acquired GPS fix of the vehicle.

When the auto-locate function is initiated, the user may manually pan a displayed map until the navigation unit obtains a first valid GPS fix for the vehicle. Once a valid GPS fix is obtained, the map is automatically panned so that vehicle is positioned at the centre of the screen. If the vehicle moves, the map is automatically panned to keep the vehicle icon centred on the screen. The zoom level of the map may be changed at any time whilst the auto-locate function is activated, and the auto-scrolling of the map will continue in accordance with the movement of the vehicle.

If the auto-locate function is de-activated, the map display will continue to update the vehicle position on the map, but the map will no longer be automatically panned in accordance with the movement of the vehicle. Consequently depending on the movement of the vehicle, the vehicle may move outside the range of the currently displayed map, in which case the vehicle icon will disappear from the map display, unless the user manually pans the map to compensate for the movement of the vehicle.

If the auto-locate function is not enabled, a displayed map can be panned manually to track the movement of the vehicle.

### 2. Advanced Display Mode Functions

(a) Live Traffic Information Function

Traffic congestion is shown on a currently displayed map using icons superimposed on the corresponding locations on the map. The color of a congestion icon represents the degree of congestion at the particular location relative to the free-flowing traffic state. The number of congestion icons and their distribution on a map indicate the extent of the congestion within the geographical area encompassed by the displayed map. The congestion icon can also include a numeric representation of the average speed of traffic at the affected location, or alternatively a numeric representation of the delay to be expected at the affected location.

Congestion icons are designed to flash when superimposed on a displayed map, to attract the driver's attention and reveal map detail which may be concealed beneath the icons. All of the displayed congestion icons flash at the same rate. However, when there are delays in both directions at a particular location, the flashing of oppositely disposed icons is sequenced, so that the congestion in each direction is shown separately.

If a map were to be displayed at a low magnification (i.e. low level of resolution) a normal congestion icon might be shrunk to the extent that it would be too small to be noticed by the driver. To overcome this problem, a specialised LED style congestion icon is used on maps displayed at low magnification. Such LED style congestion icons do not contain numerical information, but are instead color coded in accordance with the degree of traffic congestion at a particular point.

(b) Current Route Display Function

When a route has been downloaded to the in-vehicle device it is displayed as a highlighted trace superimposed on the currently displayed map. Routing information may include roads that are not held in the color display unit map database and these will be plotted based on vectors supplied by the in-vehicle device's navigation unit. Once the plotted journey is underway the highlighting on the route will be greyed-out as the vehicle proceeds along it.

In a ninth embodiment of the route guidance system, the current route display function is intimately linked with the previously described smart start system and route convergence model. In order to plot the current route of a vehicle, at any given route key-point it is necessary to select and display the branch which most closely reflects the most recent manoeuvres of the vehicle. Consequently, the current route display function employs a dynamic selection and replotting algorithm to provide a real-time display of the most suitable route for the vehicle to its destination. The process of selecting the most suitable branch for the vehicle can be very broadly described in terms of the following steps:
(i) Before the navigation unit has determined that the vehicle has reached one of the route key-points, a “default” branch is displayed by the color display unit
(ii) Once the navigation unit has determined that the vehicle has reached a route key-point on one of the branches, the current route display function identifies the branch corresponding to the reached route key-point and the color display unit displays the path ahead to the next route key-point on the branch
(iii) As the vehicle reaches further route key-points, the current route display function identifies its corresponding branch and displays the path ahead to the next route key-point on the branch.

If a number of branches emanate from the last route key-point reached by the vehicle, a branch is selected by the current route display function and the next route key-point along the selected branch is determined. The color display unit then displays the route ahead to the next route key-point on the selected branch. If the vehicle passes this route key-point, the current route display function determines the next route key-point along the present branch.

For example, consider the situation in which a vehicle encounters a fork with two potential branches Branch₁ and Branch₂. In this case the current display function selects a branch, e.g. Branch₁ and determines the next route key-point along Branch₁, namely Key_point_{x,1}. The current display unit then displays the route ahead for the vehicle from its current position at the fork to Key_point_{x,1}. If the navigation system determines that the vehicle has passed Key_point_{x,1}, the current display function determines the next route key-point along the branch, namely Key_point_{x+1,1}.

However, if the initial route key-point on the selected branch is not passed by the vehicle, it is likely that the driver drove onto the branch which was not selected and displayed by the current display function. In this case, the current display switches to the unselected branch and displays the route ahead to the next route key-point on the newly selected branch. Using the same example as before, should the navigation unit determine that the vehicle did not pass Key_point_{x,1}, the current display function switches to Branch₂ and displays the route from the fork to Key_point_{x,2}. If the vehicle passes Key_point_{x,2} the current display function displays the route ahead to the next route key-point on the branch, namely Key_point_{x+1,2}.

(c) Junction Display Function

### (i) Simple Junctions

If a driver is approaching a junction, the junction display function displays the junction in a geographically-indicative pictogram similar to a road-sign. The pictograms essentially take the form of the pictograms displayed by the monochrome display unit (see FIGS. 5a and 5b)

If a vehicle passes a preparation point (e.g. 1 mile in advance of a motorway junction), a pictogram representing the junction is inset on a portion of the currently displayed map and the navigation unit issues an audible message, warning the driver of the nearby junction. The pictogram includes information identifying the road which the driver should take from the junction and an indication of the current distance to the junction.

If the vehicle passes a warning point or an instruction point (e.g. 400 yards in advance of a junction) or a confirmation point (between compounded junctions) a full-screen pictogram of the junction is displayed unless suppressed by the driver and a further audible warning message is issued to the driver.

The full-screen pictogram of the junction includes information identifying the name and/or number of the exit road to be taken from the junction, together with an indication of the class of the exit-road. The pictogram also includes information identifying the name and/or number of the current i.e. entry road together with an indication of its class. The full-screen pictogram finally includes an indication of the current distance to the junction.

Once the vehicle has passed the junction, the full-screen pictogram of the junction is removed from the color display unit and the current map is re-displayed to the driver. Similarly if the driver deviates from the route to the junction, the junction pictogram is removed and the current map is re-displayed to the driver.

### (ii) Compound Junctions

The color display unit is also capable of displaying compound junctions (in a similar way to the monochrome display unit).

If successive junctions along a prescribed route are located sufficiently close together it may not be possible to place the normal full complement of preparation points, warning points, instructions points between them and it may be necessary to use a restricted set of such route key-points to advise the driver of the required manoeuvre. For example, if a second turning is positioned within 600 yards of a first turning, it may not be possible to place a preparation point, warning point and instruction point between the turnings and the motorist will have to rely on the warning point and instruction point messages. As the distance between successive turnings decrease, the number of points available for providing messages to users also decrease. In extreme cases, there may not be enough space to place any preparation points, warning points, instruction points between successive junctions.

In the circumstance where junctions are located so close together that it is not possible to place any route key-points between the corresponding manoeuvre points, the junctions are shown in the full-screen pictogram as a compound series (as shown in FIG. 8). The color display unit can display a compound series comprising two junctions of any type or up to two roundabouts combined with one radial junction. As a car approaches one of these compound junctions, the color display unit displays a full-screen pictogram of the entire compound series. The full-screen pictogram also displays text identifying the name or number of the entry road to the first junction and the name or number of the exit road from the last junction of the compound series. A compound instruction such as “turn right and then immediately turn left” is issued at the instruction point before the first manoeuvre.

As the car passes through the first junction of the compound series and approaches each later junction, the full-screen pictogram only displays the sub-junction in question.

To ensure display of the next pictogram as soon as possible after negotiating the first junction, the display reverts to a map once the first candidate route point has been reached after any compound manoeuvre. A maximum of three junctions can be compounded in this manner.

(iii) Un-encoded Junctions

Depending on the optimal route determined by the central route advisory system, the driver may merely be required to drive straight through a junction (i.e. neither turn right nor left, nor turn around a roundabout).

In these cases the navigation server neither encodes speech nor pictograms for the junction and merely places confirmation points around the junction to detect whether the driver has turned on the junction rather than going straight through it and as a result has driven the car “off-route” (i.e. the navigation server only places confirmation points around the un-encoded junctions for off-route detection). These unencoded junctions may be recognised via their “CP-triplet” signature (as previously described).

(d) Compass Aid Function

Should a driver lose his way from a pre-defined optimal route, audible instructions to the driver are often not very helpful for assisting the driver to regain his route. Similarly, should the driver change his mind as to his desired destination, audible instructions are not very helpful for enabling a driver to lock on to a new route.

In these circumstances, the compass aid function provides an indicator in the form of an inset onto the currently displayed map showing a dart pointing to the nearest route key-point marker. On reaching this marker, the optimal route to the desired destination is re-calculated and displayed.

The processing algorithm for the Compass Aid proceeds as follows:

1. While Guidance is active but the vehicle is not on-route, on passing a route point the in-vehicle device determines the “best” route key-point within the current scanning window for (re)gaining the prescribed route as follows;

2. If there are no candidate route key-points (i.e. none within the speed-dependent matching radius) then a successor of the nearest route key-point is used (see 4 below);

3. If candidate route key-points are found (i.e. within the speed-dependent matching radius) then a successor of the candidate with the highest “benefit” (i.e. considering both proximity and alignment) is used;

4. In both cases 2, 3, the “best” (to be pointed at) is the first route key-point at least 30 yards from the current vehicle position found by tracing successors along the relevant “branch”;

5. The in-vehicle device calculates the angle between the current GPS heading and the azimuth of the selected “best” route key-point, and sends this angle to the display unit which responds by displaying a dart graphic with 16 possible orientations;

The compass aid function has two further modes of operation, namely manual and automatic re-routing modes.

In automatic re-routing mode, once the in-vehicle device detects that the user has driven off a prescribed route, the in-vehicle device initiates a silent call to the central route advisory system (ie without alerting the user). If during the call, the in-vehicle device detects that the user has re-gained the prescribed route, the silent call is terminated without making the user aware of the activities of the in-vehicle device. However, if the in-vehicle device detects that the user has not regained the prescribed route, it issues a beep to warn the user and a new route is calculated based on the current position of the vehicle.

In manual re-routing mode, if the in-vehicle device detects that the user has driven off the prescribed route, it will issue an audible warning to the user, for example, “no longer on route, please do a U-turn where safe”. However, if the user is unable to safely perform the U-turn, the user may manually initiate a re-route request call to the central route advisory system.

(e) Exit Indicator Function

Exit indicators provide an enhanced visual indication of the exit direction from roundabouts and radial un-encoded junctions.

The exit indicators dynamically change according to the movements of the vehicle at the relevant junction. In the case of a roundabout, the exit indicator moves around the circular pictogram (representing the roundabout) as the vehicle itself moves around the roundabout. In the case of a radial junction, the exit indicator is adjusted as the vehicle approaches the junction.

(f) Safety Camera Warning Function

The navigation unit uses this function to generate audible warnings to the driver of nearby road-side speed cameras. In addition, the color display unit displays an icon depicting the camera and an indication of the speed limit relevant to the camera.

### 3. Telephone Functions

Calls to the call centre are not regarded as “user” voice calls because the in-vehicle navigation unit always follows up such calls with a data call to the central route advisory system.

The color display unit provides a user interface to enable a driver to use the in-vehicle mobile telephone device to make and receive conventional voice-calls. The in-vehicle mobile telephone device can also be used to receive text messages which can be displayed on the color display unit. These facilities are made possible by the telephone functions of the color display unit.

The telephone functions can be broadly divided into functions for making and receiving voice calls and functions for receiving and displaying text messages. These functions will be described in more detail below.

### (a) Voice Calls

The telephone: voice calls function enables a user to use the touch screen of the color display unit as a telephone keypad similar to the keypad of a conventional mobile phone. The color display unit telephone keypad may then be used as a user-interface to the in-vehicle mobile telephone device to enable the driver to make a voice call to a desired telephone number.

On activating the telephone option the user is provided with the following functions:

(a) Keypad
Converts the color display unit touch screen into a telephone key-pad. As a number is entered by the driver, the number is displayed on the color display unit.

(b) Store and Recall
The mobile telephone device in the in-vehicle device includes a memory for storing up to ten frequently used telephone numbers. Each of these numbers has an associated single digit identifier. The store function enables a user to store a number in the mobile telephone device memory in which case the stored number is automatically allocated a number which acts as its identifier. The user can display a stored number using the recall function together with the single digit identifier. The recalled number can then be dialled using the call function.

(c) Recall

(d) Call
Submits the number entered by the driver to the mobile telephone device for dialling. If the recipient telephone system is engaged, the call function is switched to a redial mode, until the user exits the telephone function menu. Alternatively, if the call is connected to the recipient, the “store” and “recall” functions are suppressed.

(e) Delete
Removes individual digits from an entry or the entire entry itself.

The above functions enable a driver to make a call from the in-vehicle device. However, the in-vehicle device may also be used to receive calls from external sources. In this case, the color display unit displays the telephone number of the incoming call and the driver is provided with the option to accept or reject the call.

Suppression of Spoken Instructions

During a voice call or the ringing of the in-vehicle device's mobile phone (on receipt of an incoming telephone call)the in-vehicle device cannot play audible instructions to the driver because the in-vehicle device's audio output is being used for the voice call. In circumstances such as this, the normal instruction playback functions of the in-vehicle device are suppressed in favour of the ongoing voice call. When it is necessary for the navigation unit to provide guidance instructions etc. to the driver, the navigation unit generates a discreet alert tone, whereupon the driver can use a repeat function to interrupt the voice call (without disconnecting the caller). In this case, the navigation unit temporarily takes over control of the audio system of the in-vehicle device to repeat the instruction to the driver. When the instruction message is completed, the navigation unit releases control of the audio system to the audio system.

Should the driver not wish to interrupt the current voice-call with the guidance instruction from the navigation unit, the driver may continue with the voice call and once the call has ended, use the repeat function to repeat the last instruction.

SOS Facility

The in-vehicle device software includes an optional facility to enable a user to call for assistance in cases of emergency and breakdown and to transmit an SMS message indicating the location of the caller to the operator of the emergency service. On initiating the SOS call, any active calls to the in-vehicle device (user voice calls, calls to the central route advisory system or route uploads) are terminated immediately.

### (b) Text Messaging

The in-vehicle can also display text-based information of the following categories:

(a) Incident

(b) Text Messages

(a) Incident Information

Text based “incident” messages may be transmitted to a driver as a supplement to the icon based display of traffic delays. These “incident” messages convey specific incident information, e.g. relating to accidents or road closures. The information is encoded to relate to specific geographical areas within the country and the user will only be alerted to the incident if it is relevant to the currently displayed map area.

(b) Text Messages

As discussed above, the in-vehicle device may display received SMS messages. SMS messages from certain designated sources are used solely by the navigation unit and are not displayed to the user. Messages from any other sources are deemed “personal” and displayed to the user. Up to 10 SMS messages may be stored in a non-volatile memory associated with the in-vehicle device mobile telephone.

Both the textual content of any stored SMS messages and the CLI (phone number) of the caller can be displayed together with an icon indicating whether the message has been read or not.

### B. Guidance Active Mode

In guidance active mode, the navigation device actively advises the user of the optimal route to a required destination. The touch-screen of the color display unit thus acts as a user interface to the in-vehicle navigation unit enabling the user to make a manual voice call to the central route advisory system before commencing a journey requesting routing advice to the desired destination.

Furthermore, the user can use the touch screen of the color display unit to request a new route to the destination even if the vehicle is progressing along a previously downloaded optimal route to the destination. In this case the navigation unit cancels the old route and continues with the new route.

In addition, if the driver has deviated from the previously prescribed route, the driver can request the route guidance system to prepare a new route to the required destination, using the re-route function.

Finally, the driver can reversibly mute audible guidance or traffic-related instructions. In this case the in-vehicle navigation unit continues scanning and matching route key-points but suppresses off-route re-route processing and the display of junction pictograms.

### C. Inactive Guidance Mode

In the guidance inactive screen mode the user can obtain guidance instructions to a particular destination with making a manual call to the central route advisory system. In this case, route requests are made automatically by the in-vehicle device in accordance with the request of the user.

In particular a driver may request a route to a destination selected from a set of saved favourite destinations. In this case the selected destination is transmitted to the navigation server (without requiring human operator intervention) and after validating the destination, the server automatically transmits the route to the in-vehicle navigation unit.

Similarly, the user may request a route to a previously visited destination. In use a navigation unit of an in-vehicle device stores in an on-board memory, the latitude and longitudes of the most recent previously requested destination. When the driver selects the previous destination option, the latitude and longitude of the destination are automatically transmitted to the navigation server which transmits an appropriate route to the in-vehicle device navigation unit.

It will be understood that since the vehicle's location may have changed since the request was made for a route to the previous destination and the prevailing traffic conditions may have also changed, that the route transmitted by the navigation system server may differ from the route previously suggested to the destination.

Finally, the driver may identify a destination according to its post-code. In this case the post-code is automatically transmitted to the navigation server (without requiring human operator intervention) and the route is automatically transmitted back to the driver's navigation unit.

### D. Help Mode

When the color display unit is operating in help mode, the user can customise the sounds produced by the in-vehicle device. For example, the user can enable or disable the sounding of a warning tone when a text message is received by the in-vehicle device and can also change the volume of audible warning messages.

Similarly, the user can customise the guidance menus displayed by the color display unit, so for example, the color display unit may be directed to display pictographic representations of junctions only and suppress the display of map information. Furthermore, the user can also customise screen and display attributes.

This invention is not limited to the embodiments herein described which can be varied in construction and detail.

1. A route guidance system comprising an in-vehicle device and a central route advisory system in which the in-vehicle device comprises an audio emitter and a visual display unit adapted to provide audio and visual instructions to a user to perform manoeuvres required to complete an optimal route, wherein the optimal route is transmitted by the central route advisory system to the in-vehicle device in response to a route request from the user to a human operator in the central route advisory system to a specified destination.

2. A route guidance system as claimed in claim 1 wherein the visual display unit is a monochrome display.

3. A route guidance system as claimed in claim 1 or claim 2 wherein the system comprises a means for displaying on the visual display unit a junction or roundabout as the vehicle approaches it.

4. A route guidance system as claimed in any one of the preceding claims wherein the system comprises a means for displaying on the visual display unit junctions as pictographs.

5. A route guidance system as claimed in any one of the preceding claims wherein the system comprises means for displaying on the visual display unit roundabouts as pictographs.

6. A route guidance system as claimed in claim 4 or claim 5 wherein the system comprises a means for indicating on the displayed pictograph the required manoeuvre.

7. A route guidance system as claimed in claim 6 wherein the system comprises a means for supplementing the visual instructions to perform a manoeuvre with audible instructions to perform a manoeuvre.

8. A route guidance system as claimed in any one of the preceding claims wherein the visual display unit provides a means of initiating an automatic route request in respect of a stored destination.

9. A route guidance system as claimed in any one of the preceding claims wherein the system comprises a means for displaying on the visual display unit the proximity of speed-cameras.

10. A route guidance system as claimed in any one of the preceding claims wherein the visual display unit is a color display unit.

11. A route guidance system as claimed in claim 10 wherein the system comprises a means for displaying on the color display unit coloured road-maps of a particular region.

12. A route guidance system as claimed in claim 10 or claim 11 wherein the system comprises a means for superimposing onto a coloured road-map the current position of the car.

13. A route guidance system as claimed in any one of claims 10 to 12 wherein the system comprises a means for superimposing onto a coloured road-map the pictograph of a junction or roundabout.

14. A route guidance system as claimed in any one of claims 10 to 13 wherein the system comprises a means for providing a user-face on the color display unit and a means for enabling a user to make a telephone call.

15. A route guidance system as claimed in any one of claims 10 to 14 wherein the system comprises a means for providing a user-interface on the color display unit and means for enabling the user to receive a telephone call.

16. A route guidance system as claimed in any one of claims 10 to 15 wherein the system comprises a means for providing a user-interface on the color display unit and means for enabling the user to receive a text-message.

17. A route guidance system comprising an in-vehicle device and a central route advisory system in which the in-vehicle device comprises units adapted to provide instructions to a user to perform manoeuvres required to complete an optimal route, wherein the optimal route is determined by the central route advisory system using real-time historical traffic data acquired from monitored routes together with archive data acquired from non-monitored routes and transmitted by the central route advisory system to the in-vehicle device in response to a route request from the user to a human operator in the central route advisory system to a specified destination.

18. A route guidance system comprising an in-vehicle device and a central route advisory system in which the in-vehicle device comprises units adapted to provide instructions to a user to perform manoeuvres required to complete an optimal route, wherein the optimal route is calculated by the central route advisory system using a traffic forecasting model and transmitted by the central route advisory system to the in-vehicle device in response to a route request from the user to a human operator in the central route advisory system to a specified destination.

19. A route guidance system as claimed in claim 18 wherein the traffic forecasting model is time dependent.

20. A route guidance system as claimed in claim 18 or claim 19 wherein the central route advisory system comprises a means of predicting future traffic conditions based on the time at which the route request was received together with the time dependent traffic forecasting model.

21. A route guidance system comprising an in-vehicle device and a central route advisory system in which the in-vehicle device comprises units adapted to provide instructions to a user to perform manoeuvres required to complete an optimal route, wherein the optimal route is calculated by the central route advisory system taking into account the previous travelling direction of the vehicle, in response to a route request from the user to a human operator in the central route advisory system to a specified destination, and the optimal route is transmitted by the central route advisory system to the in-vehicle device.

22. A route guidance system comprising an in-vehicle device and a central route advisory system in which the in-vehicle device comprises units adapted to provide instructions to a user to perform manoeuvres required to complete an optimal route, wherein the optimal route is calculated by the central route advisory system taking into account the previous travelling direction of the vehicle, in response to a route request from the user to a human operator in the central route advisory system to a specified destination, and the optimal route is transmitted by the central route advisory system to the in-vehicle device.

23. A route guidance method comprising the steps of:
(a) receiving a call from a user's in-vehicle device indicating the user's desired destination;
(b) entering the user's desired destination into a route-guidance system;
(c) determining the current location of the user's vehicle;
(d) determining the potential routes to the desired destination;
(e) ascertaining traffic conditions along the potential routes;
(f) determining the optimal route to the desired destination using the distances of the potential routes and the traffic conditions along the routes;
(g) establishing route key-points along the optimal route;
(h) associating flags with the route key-points;
(i) transmitting the route key-points and flags to the user's in-vehicle device; and
(j) providing visual and audio instructions to the user as the user's vehicle approaches the route key-points along the optimal route.

24. A route guidance method comprising the steps of:
(a) receiving a call from a user's in-vehicle device indicating the user's desired destination;
(b) determining the current location of the user's vehicle;
(c) entering the user's desired destination into a route-guidance system;
(d) determining the potential routes to the desired destination;
(e) ascertaining traffic conditions along the potential routes;
(f) determining the optimal route to the desired destination using the distances of the potential routes and the traffic conditions along the routes;
(g) establishing route key-points along the optimal route;
(h) associating flags with the route key-points;
(i) transmitting the route key-points and flags to the user's in-vehicle device; and
(j) providing instructions to the user as the user's vehicle approaches the route key-points along the optimal route.

25. A route guidance method comprising the steps of:
(a) receiving a call from a user's in-vehicle device indicating the user's desired destination;
(b) entering the user's desired destination into a route-guidance system;
(c) determining the current location of the user's vehicle from a dual multi-frequency tone transmission from the user's in-vehicle device;
(d) determining the potential routes to the desired destination;
(e) ascertaining traffic conditions along the potential routes;
(f) determining the optimal route to the desired destination using the distances of the potential routes and the traffic conditions along the routes;
(g) establishing route key-points along the optimal route;
(h) associating flags with the route key-points;
(i) transmitting the route key-points and flags to the user's in-vehicle device; and
(j) providing instructions to the user as the user's vehicle approaches the route key-points along the optimal route.

26. A route guidance method as claimed in claim 25 wherein the current position of the user's vehicle is determined from an ISDN sub-addressing transmission from the user's in-vehicle device.

27. A route guidance method comprising the steps of:
(a) receiving a call from a user's in-vehicle device indicating the user's desired destination;
(b) entering the user's desired destination into a route-guidance system;
(c) determining the current location of the user's vehicle;
(d) determining the potential routes to the desired destination;
(e) ascertaining traffic conditions along the potential routes;
(f) determining the optimal route to the desired destination using the distances of the potential routes and the traffic conditions along the routes;
(g) establishing route key-points along the optimal route;
(h) associating flags with the route key-points;
(i) transmitting the route key-points and flags to the user's in-vehicle device;
(j) using a route convergence model to determine the direction in which the user's vehicle is travelling once the vehicle commences the journey along the optimal route; and
(k) providing visual and audio instructions to the user as the user's vehicle approaches the route key-points along the optimal route.

28. A route guidance method as claimed in claim 27 wherein the in-vehicle device uses the route convergence model to display the current route on which the vehicle is travelling.
